(19) United States
(12) Patent Application Publication
(10) Pub. No.: US 2015/0231512 A1
(43) Pub. Date: Aug. 20, 2015

(54) ILLUMINATED DEVICE

(71) Applicant: Brand 44 Trading, LLC, Denver, CO (US)

(72) Inventors: Ed O'Brien, Denver, CO (US); Furman O'Dell, Evergreen, CO (US); Jonathan Curts, Parker, CO (US); Tom Walker, Denver, CO (US)

(73) Assignee: BRAND 44 TRADING, LLC, Denver, CO (US)

(21) Appl. No.: 14/180,786

(22) Filed: Feb. 14, 2014

(51) Int. Cl. A63G 9/00; F21V 19/00; F21V 3/04; F21V 33/00

(52) U.S. Cl. CPC A63G 9/00; F21V 33/008; F21V 19/0065; F21V 3/04

(57) ABSTRACT

An illuminated device is disclosed which can be used as a seat for a swing or zipline. The device includes an outer shell, a plurality of sockets formed in a tray or the inside of the outer shell, a plurality of light-emitting elements disposed in the sockets and facing an outer periphery of the outer shell, a plurality of retainers fitting into the sockets and retaining the light-emitting elements in the sockets, and an upper lid closing a cavity defined by the outer shell. The sockets each include an upward opening groove formed in at least the rear wall of the socket, and the light-emitting elements are disposed in the upward opening groove. The retainers have a downward-opening groove in which the light-emitting elements are retained. The device may also include downward-facing light emitting elements immobilized in bosses of the outer shell, by the tray.

### BACKGROUND OF THE INVENTION

1. Field of the Invention

The invention relates to an illuminated device, particularly an illuminated seat for a swing or a zipline device.

2. Description of Related Art

Swings and ziplines are commonly used for recreation. In the case of a swing, a rope or the like can be secured to a fixed object, such as a branch of a tree, and the user can hold onto the rope while swinging. In the case of a zipline, a cable is attached to two fixed objects, such as trees or buildings, and a zipline trolley travels on the cable between these two fixed objects. In the case of a zipline, the user holds onto handles of the zipline trolley.

However, the above-described usage may be difficult for young children and those with very little upper body strength. Accordingly, a seat can be utilized so as to avoid the need for the user to support themselves. In the case of a swing, the seat is attached to the rope. In the case of a zipline, a rope is attached to the zipline trolley, and the rope is also attached to the seat. An example of such a seat is the seat used in the “Spring Swing” sold by Swing Swings LLC of Port St. Lucie, Fla. (www.springswings.com).

### SUMMARY OF THE INVENTION

According to a first feature, an illuminated device comprises an outer shell defining a cavity therein, a plurality of sockets disposed within the cavity of the outer shell, around a periphery of the outer shell, the plurality of sockets each comprising at least a pair of opposing side walls and a rear wall having an upward-opening groove formed therein, a plurality of light-emitting elements fitted into the upward-opening grooves formed in the rear walls of the plurality of sockets, and a plurality of retainers disposed in the plurality of sockets. The plurality of light-emitting elements are each held by the upward-opening groove formed in the rear wall of one of the plurality of sockets and one of the plurality of retainers.

According to a second feature, the illuminated device further comprises a tray removably disposed within the outer shell, the tray comprising the plurality of sockets on an outer periphery thereof, each of the plurality of sockets comprising the two opposing side walls, a front wall orthogonal to the two opposing side walls, and the rear wall, orthogonal to the two opposing side walls. The front wall and the rear wall connect the two opposing side walls, the front wall having an upward-opening groove formed therein, and the plurality of light-emitting elements are each held by the upward opening groove formed in the front wall of one of the plurality of sockets, the upward opening groove formed in the rear wall of the one of the plurality of sockets, and one of the plurality of retainers.

According to a third feature the plurality of retainers are removably inserted in the plurality of sockets.

According to a fourth feature, the plurality of retainers each comprise two leg portions defining a downward-opening groove therebetween, the plurality of light-emitting elements being disposed within the downward-opening grooves of the plurality of retainers.

According to a fifth feature, the plurality of retainers each comprise a ridge formed on an inner surface of the downward-opening groove, and the ridge abuts a rear shoulder of one of the plurality of light-emitting elements.

According to a sixth feature, the plurality of sockets further comprise a reinforcing beam which connects a midpoint of the front wall and a midpoint the rear wall, such that the light-emitting element is disposed above the reinforcing beam and at least partially below one of the plurality of retainers.

According to a seventh feature, the outer shell comprises mounting bosses on an inner surface of a bottom portion of the outer shell, and the tray is removably attached to the outer shell by a connector which connects the tray to the mounting bosses.

According to an eighth feature, the outer shell further comprises light-emitting element receiving bosses adjacent to the mounting bosses, and the tray is removably attached to the outer shell such that light-emitting elements are immobilized in the light-emitting element receiving bosses by the tray.

According to a ninth feature, an outer peripheral wall of the outer shell is circular in plan view.

According to a tenth feature, a hole is formed in the outer shell at a central portion, in plan view, such that a rope or cable is insertable therethrough.

According to an eleventh feature, the plurality of light-emitting elements are electrically connected to a power source and a controller by wiring.

According to a twelfth feature, a plurality of holes are at least partially formed in an outer peripheral wall of the outer shell, the plurality of light-emitting elements being at least partially inserted into the plurality of holes, and the upward-opening grooves formed in the rear walls of the plurality of sockets are aligned with the plurality of holes.

According to a thirteenth feature, a plurality of holes are at least partially formed in an outer peripheral wall of the outer shell, the plurality of light-emitting elements being at least partially inserted into the plurality of holes, and the upward-opening grooves formed in the front and rear walls of the plurality of sockets are aligned with the plurality of holes.

According to a fourteenth feature, the outer shell is translucent or transparent.

According to a fifteenth feature, the illuminated device further comprises one or more counterweights removably inserted into one or more spaces between adjacent sockets among the plurality of sockets, said one or more counterweights each comprising a hook which can be disposed on a connecting wall which connects rear walls of said adjacent sockets among the plurality of sockets.

According to a sixteenth feature, the counterweights each include a tower portion extending from an upper surface of a body of said counterweights, the upper surface of said tower portion abutting an inner surface of an upper lid which closes the cavity defined by the outer shell.

According to a seventeenth feature, an illuminated device comprises an outer shell defining a cavity therein, a tray removably disposed within the outer shell, the tray comprising a plurality of sockets on an outer periphery thereof, each of the plurality of sockets comprising two opposing side walls, a front wall orthogonal to the two opposing side walls, and a rear wall orthogonal to the two opposing side walls, and a reinforcing beam which connects a midpoint of the front wall and a midpoint of the rear wall, and a plurality of retainers removably inserted in the plurality of sockets, the plurality of retainers each comprising two leg portions defining a downward-opening groove therebetween and having a ridge formed on an inner surface of the downward-opening groove. The front wall and the rear wall connect the two opposing side walls, the front wall and the rear wall each having an upward-opening groove formed therein. A plurality of light-emitting elements are inserted into the upward opening grooves formed in the front walls and the rear walls of the plurality of sockets, such that each of the plurality of light-emitting elements is disposed above the reinforcing beam and at least partially below one of the plurality of retainers. The ridge formed on the inner surface of the downward-opening groove of the retainer abuts a rear shoulder of one of the plurality of light-emitting elements. The plurality of light-emitting elements are each held by the upward opening groove formed in the front wall of one of the plurality of sockets, the upward opening groove formed in the rear wall of the one of the plurality of sockets, and one of the plurality of retainers, and are disposed within the downward-opening groove of the one of the plurality of retainers. A plurality of holes are at least partially formed in an outer peripheral wall of the outer shell, the plurality of light-emitting elements being at least partially inserted into the plurality of holes. The upward-opening grooves in the front and rear walls of the plurality of sockets are aligned with the plurality of holes.

According to an eighteenth feature, the outer shell comprises mounting bosses on an inner surface of a bottom portion of the outer shell, the tray is removably attached to the outer shell by a connector which connects the tray to the mounting bosses, the outer shell further comprises light-emitting element receiving bosses adjacent to the mounting bosses, and the tray is removably attached to the outer shell such that light-emitting elements are immobilized in the light-emitting element receiving bosses by the tray.

According to a nineteenth feature, the outer shell is translucent or transparent.

### BRIEF DESCRIPTION OF THE DRAWINGS

The advantages of the invention will become apparent in the following description taken in conjunction with the drawings, wherein:

FIG. 1 is a perspective partially exploded view of an embodiment of the illuminated device;

FIG. 2 is a perspective view of the tray according to one embodiment of the illuminated device;

FIG. 3 is a magnified view of one socket of the illuminated device;

FIG. 4A is a top view of the retainer of the illuminated device;

FIG. 4B is a perspective view of the retainer of the illuminated device;

FIG. 4C is a front view of the retainer of the illuminated device;

FIG. 4D is a side view of the retainer of the illuminated device;

FIG. 4E is a back view of the retainer of the illuminated device;

FIG. 4F is a bottom view of the retainer of the illuminated device;

FIG. 5 is a side view of an embodiment of the illuminated device, denoting a detail;

FIG. 6A is an enlarged view of the detail denoted in FIG. 5;

FIG. 6B is a cross-sectional view taken along the line 6B-6B in FIG. 6A;

FIG. 7A is an exploded view of detail illustrated in FIG. 6A;

FIG. 7B is a cross-sectional view taken along the line 7B-7B in FIG. 7A;

FIG. 8A is a top view of a counterweight of the illuminated device;

FIG. 8B is a perspective view of a counterweight of the illuminated device;

FIG. 8C is a front view of a counterweight of the illuminated device;

FIG. 8D is a side view of a counterweight of the illuminated device;

FIG. 8E is a back view of a counterweight of the illuminated device;

FIG. 8F is a bottom view of a counterweight of the illuminated device;

FIG. 9 is a side view of an embodiment of the illuminated device, denoting a detail;

FIG. 10A is an enlarged view of the detail indicated in FIG. 9;

FIG. 10B is a cross-sectional view taken along the line 10B-10B in FIG. 10A;

FIG. 11A is an exploded view of the detail illustrated in FIG. 10A;

FIG. 11B is a cross-sectional view taken along the line 11B-11B in FIG. 11A;

FIG. 12A is a partial top view of the illuminated device, illustrating a condition where the tray is inserted into the outer shell;

FIG. 12B is a partial top view of the illuminated device, illustrating a condition where the tray is inserted into the outer shell and light emitting elements are inserted into the sockets;

FIG. 12C is a partial top view of the illuminated device, illustrating a condition where the tray is inserted into the outer shell and both the light emitting elements and the retainers are inserted into the sockets;

FIG. 13 is a perspective view of an embodiment of the illuminated device having a cut-away portion, and denoting a detail;

FIG. 14A is a top plan view of the detail indicated in FIG. 13;

FIG. 14B is a cross-sectional view taken along the line 14B-14B in FIG. 14A;

FIG. 15 is a top perspective view of an assembled embodiment of the device;

FIG. 16 is a bottom perspective view of the assembled embodiment of the device;

FIG. 17 is a top view of the assembled embodiment of the device;

FIG. 18 is a bottom view of the assembled embodiment of the device; and

FIG. 19 is a side view of the assembled embodiment of the device.

### DETAILED DESCRIPTION OF THE INVENTION

An illuminated device is disclosed, in which can be particularly used as a seat for a swing or zipline. Such illumination of a seat can increase the entertainment value of the swing or zipline, as well as make the usable time of the swing or zipline well into evening hours. However, it was previously unknown how to construct such an illuminated seat, particularly in a cost effective manner.

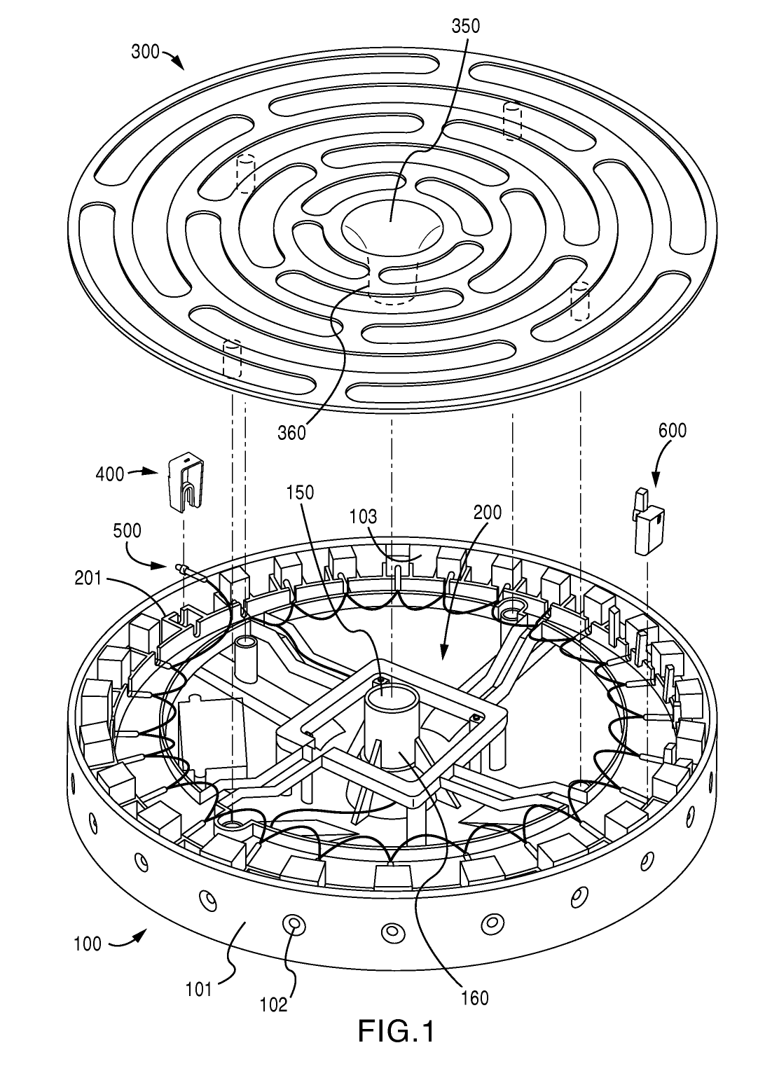

It should be initially noted that in this description, terms such as “up”, “down”, “above”, “below”, “inner”, “outer” and the like will be made in reference to the orientation of the device as illustrated in FIG. 1. Particularly, “up” and the like refers to the direction towards the top of FIG. 1, and “down” and the like refers to the direction towards the bottom of FIG. 1.

As illustrated in FIG. 1, in one embodiment of the illuminated device, the device includes an outer shell 100, a tray 200, an upper lid 300, a plurality of retainers 400, a plurality of light-emitting elements 500 and a plurality of counterweights 600. It should be noted that in FIG. 1, the retaining configuration of only one of the light-emitting elements 500 is detailed, and this is illustrated in greater detail in other Figures. The retaining configuration of other light-emitting elements 500 are illustrated in a simplified manner, and are retained by a similar configuration. It is also noted that in FIG. 1, the wiring of the light-emitting elements is only illustrated generally, and electrical connection to other elements is not specifically illustrated.

First, the outer shell 100 will be described. In the illustrated embodiment, the outer shell 100 has a circular shape in plan view, and defines a cavity. However, the outer shell 100 may have a different shape in plan view, such as an oval, octagon, hexagon, pentagon, or an irregular shape, for example. The outer shell 100 has an outer peripheral wall 101, which in the illustrated embodiment defines a generally cylindrical shape of the device. The outer shell 100 is open on the top, and is closed by the upper lid 300. The outer shell 100 may be open on the bottom, or may be closed by a bottom wall. The outer shell 100 may be formed of any appropriate material, such as plastic, rubber, metal or the like, and at least a portion of the outer shell may be translucent or transparent. In the outer peripheral wall 101, there may be formed a plurality of holes 102 into which the light-emitting elements 500, discussed below, can be inserted. The holes 102 may penetrate entirely through the outer peripheral wall 101, so that light can be seen directly. Alternatively, where the outer peripheral wall 101 is transparent or translucent, the holes 102 may only penetrate partially through the outer peripheral wall 101, so that the observed light is more diffuse, for a different optical effect. Additionally, in the case of the outer peripheral wall 101 being transparent or translucent, a hole 102 need not be formed in the outer peripheral wall 101, and the light-emitting element can be disposed so as to abut the inner surface 103 of the outer peripheral wall 101. If holes 102 are formed in the outer shell 100, the number of holes 102 or spacing thereof is not particularly limited. In one embodiment, about 20-30 holes are formed in the periphery of the outer shell, and are spaced about 0.5 inches to 1.0 inches from each other. Additionally, a hole 150 is formed in the outer shell, so as to allow a rope or the like to be passed through. A hole 350 is also formed in the upper lid, so as to allow the rope or the like to be passed through. The holes 150 and 350 communicate with each other. Specifically, the hole 150 of the outer shell 100 may be defined by a central boss 160, and the hole 350 of the upper lid 300 may be defined by a funnel portion 360. The funnel portion 360 can fit into the hole 150 of the central boss 160, such that a top surface of the central boss 160 supports a portion of the upper lid 300.

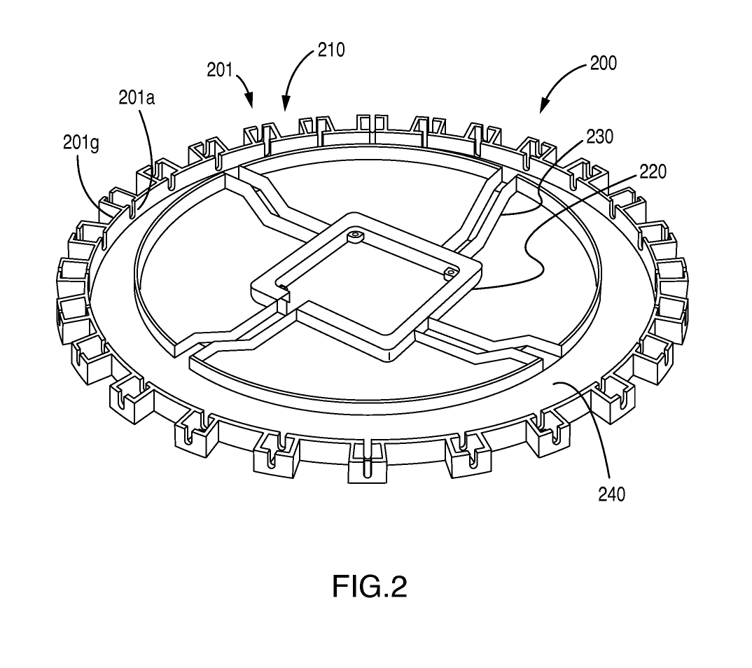

In one embodiment, the tray 200 includes a plurality of sockets 201 around the outer periphery of the tray 200. The tray 200 is illustrated in FIG. 2. In this configuration, the sockets 201 are formed as projections which project radially outward from a periphery of the tray 200, in a direction away from the center of the tray 200. However, the tray 200 can also be formed such that the sockets 201 do not project from the periphery of the tray 200, but rather are flush with the periphery of the tray 200. In either of these configurations, the sockets 201 abut the inner surface 103 of the outer shell 100. The tray 200 may be formed of any appropriate material, such as plastic, rubber, metal or the like.

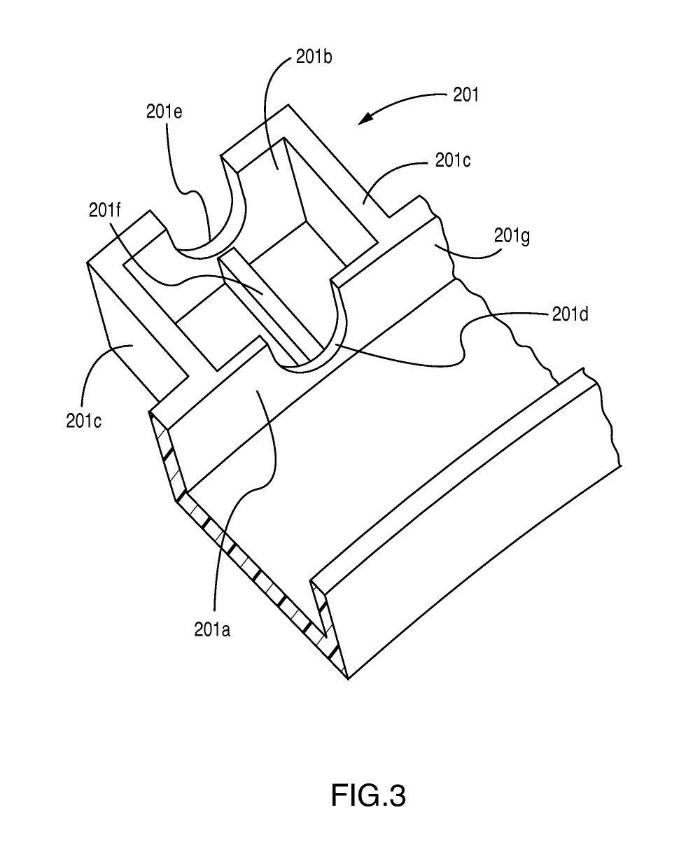

As illustrated in FIG. 3, the sockets 201 each include two opposing side walls 201c, a front wall 201b orthogonal to the two opposing side walls 201c, and a rear wall 201a orthogonal to the two opposing side walls 201c. The front wall 201b abuts the inner surface 103 of the outer shell 100. The front wall 201b, rear wall 201a and side walls 201c define the socket 201, and the upper side of the socket 201 is open. The bottom side of the socket 201 may be closed by a bottom wall, or may only include a reinforcing beam 201f which connects the front wall 201b and rear wall 201a. In the front wall 201b, there is formed an upward-opening groove 201e, and in the rear wall 201a there is formed an upward-opening groove 201d. The light-emitting element 500 is inserted into the upward-opening grooves 201d and 201e, to be described in greater detail below. The sockets 201 can be formed such that there is a space 210 between each socket 201.

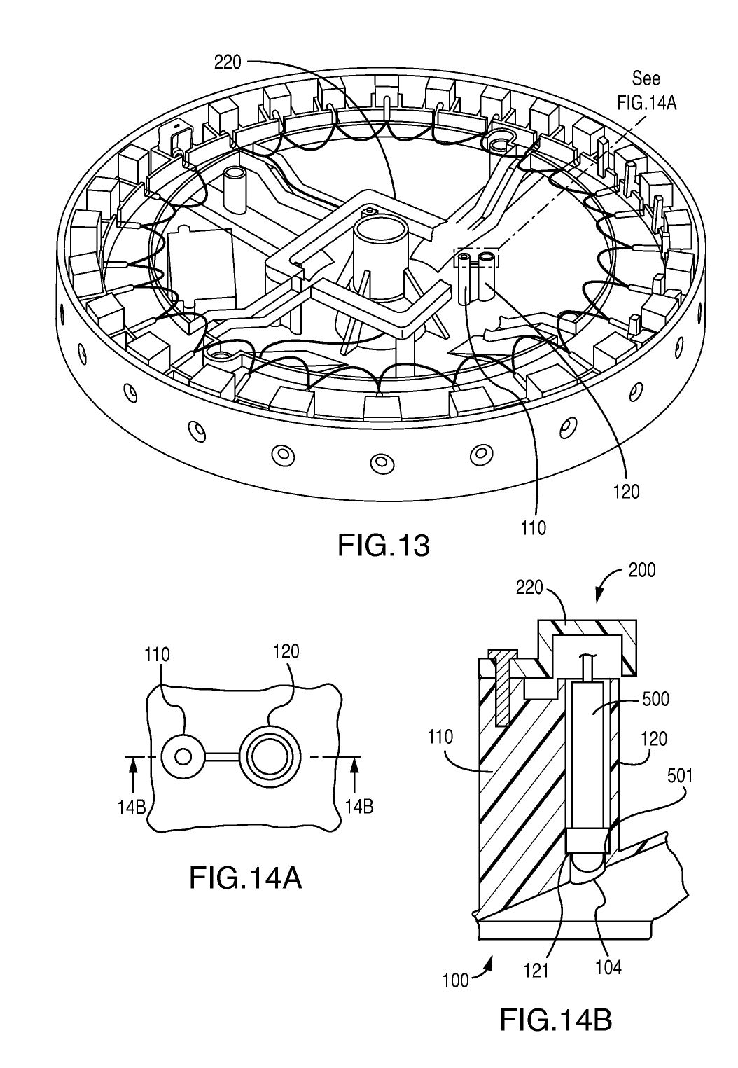

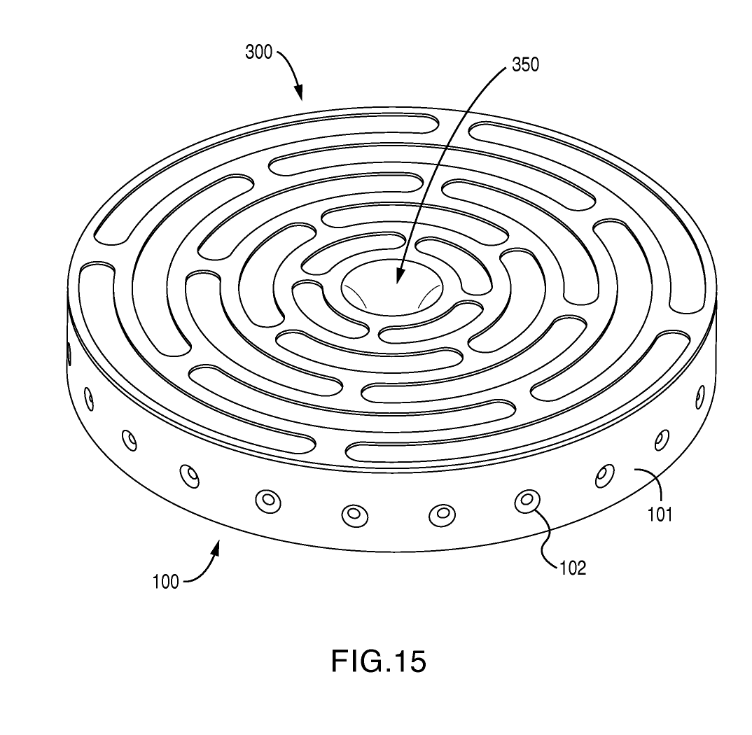

In one embodiment, as illustrated in FIG. 2, the tray 200 may include a central portion 220 which is connected to an outer portion 240 via arms 230. The outer portion 240 may have the sockets 201 formed thereon. The outer shell 100 can be formed to include mounting bosses 110 which have a hole opened on an upper end thereof (see FIGS. 13 and 14). The central retaining portion 220 is secured to the mounting bosses 110 via a screw, clip or the like. Thereby, the tray 200 can be secured.

In another embodiment, it is not necessary to include a tray 200. As such, rather than the above configuration where the tray 200 is a separately formed and removable component, the sockets 201 are formed integrally within the outer shell 100. In one such configuration, the front wall 201b of the socket 201 is integral with the inner surface 103 of the outer shell 100. The front wall 201b of the socket 201 is fused to the inner surface 103 of the outer shell 100, such that the thickness of the outer shell 100 in the region of the socket 201 is greater than the thickness of the outer shell 100 in the region of the space 210. In this case, the upward opening groove 201e can be formed in just part of the outer shell 100, in the thickness direction. The rear wall 201a includes the upward opening groove 201d.

Alternatively, in another embodiment where the tray 200 is eliminated and the sockets 201 are formed integrally with the outer shell 100, the front wall 201b can be eliminated altogether. In this case, the thickness of the outer shell 100 is uniform in regions of the sockets 201 and regions of the spaces 210. Meanwhile, the side walls 201c project inward from the inner surface 103 of the outer shell 100, and are connected by the rear wall 201a. The rear wall 201a includes the upward opening groove 201d.

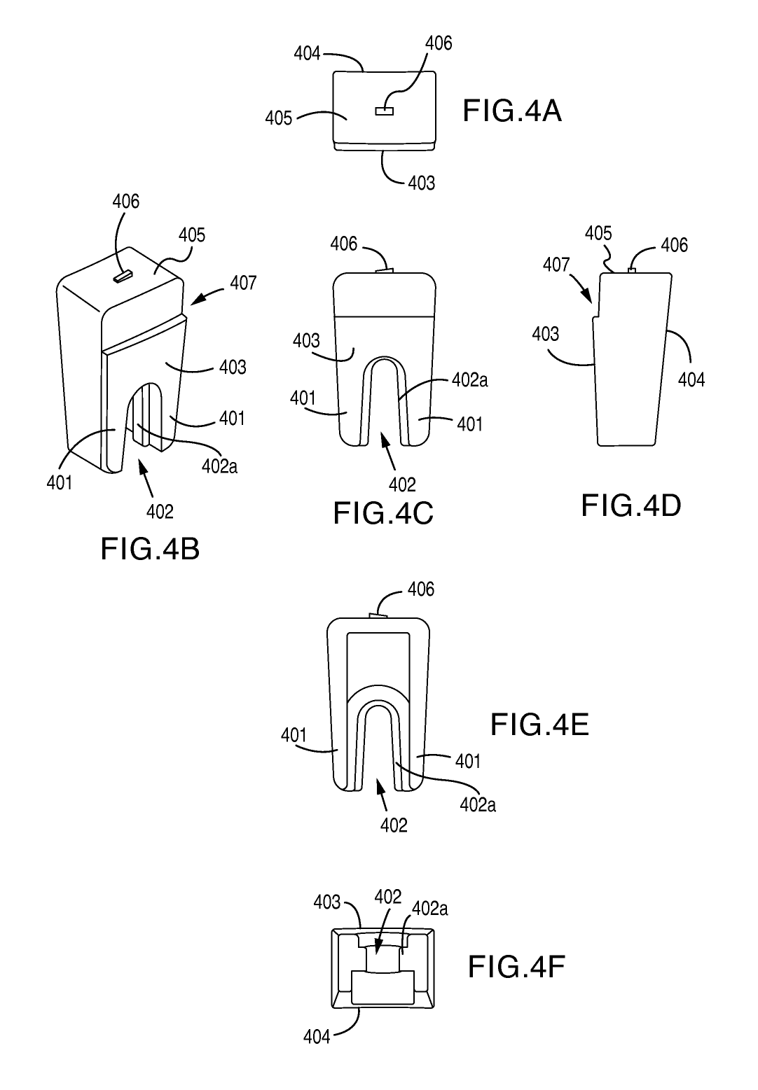

The illuminated device further includes a plurality of retainers 400. Each of these retainers 400 has a shape which generally resembles a human tooth, and is illustrated in FIGS. 4A-2F. As shown in FIG. 4D, which is a side view, the front-to-rear thickness of the retainer 400 decreases from the top of the retainer 400 towards the bottom of the retainer 400. Also, as illustrated in FIGS. 4C and 4E, which are front and rear views, respectively, the side-to-side width of the retainer 400 decreases from the top of the retainer 400 towards the bottom of the retainer 400. The retainer 400 also includes two leg portions 401 which define a downward-opening groove 402 therebetween. The downward-opening groove 402 is open from the front surface 403 of the retainer 400 to the rear surface 404 of the retainer 400. Furthermore, the retainer 400 also includes a ridge 402a projecting from the inner surface of the downward opening groove 402. Furthermore, the retainer 400 may include a top projection 406 which extends from a top surface 405 of the retainer 400 so as to contact the inside surface 301 of the upper lid 300, to thereby prevent movement in the vertical direction. The retainers 400 may be formed of any appropriate material, such as plastic, rubber, metal or the like.

The illuminated device further includes light-emitting elements 500, as discussed above. The light-emitting elements 500 can be any of any type, as long as they emit light. For example, the light-emitting elements 500 can be LEDs, OLEDs, or incandescent bulbs. The light emitting elements 500 can each be white, a single color, or multi-color. The light-emitting elements 500 may have a generally cylindrical shape. Additionally, the light emitting elements 500 may have a front shoulder 501 and a rear shoulder 502, or both, formed thereon. These shoulders 501 and 502 define a location where the diameter of the light-emitting element 500 is increased relative to another portion of the light-emitting element 500. For example, front shoulder 501 is a location where the diameter of the light-emitting element 500 increases, and rear shoulder 502 is a location where the diameter of the light-emitting element 500 decreases.

Next, assembly of the device will be described. First, in the embodiment where the sockets 201 are formed as a part of the tray 200, the tray 200 is inserted into the outer shell 100. If the outer shell 100 includes holes 102, the tray 200 is aligned such that the upward opening grooves 201d and 201e of the socket 201 are aligned with the holes 102. Then, each of the light-emitting elements 500 is inserted into the upward opening grooves 201d and 201e such that the light emitting end of the light-emitting elements 500 faces away from the center of the outer shell 100, in plan view. Thus, the light-emitting elements 500 are disposed such that an axis thereof is substantially parallel to the side walls 201c of the socket 201 and perpendicular to the front wall 201b and rear walls 201a of the socket 201. In the case of an embodiment where the sockets 201 are integral with the outer shell 100, there is no tray 200, and thus no insertion thereof. In this case, the light emitting-elements 500 are disposed such that an axis thereof is substantially parallel to the side walls 201c of the socket 201 and perpendicular to at least the rear walls 201a of the sockets 201.

Then, in each socket 201, a retainer 400 is inserted, such that the outer surfaces of the leg portions 401 abut the inner surfaces of the side walls 201c, and the light-emitting element 500 is disposed in the downward opening groove 402. The retainer 400 is inserted such that a front surface 403 thereof abuts the inner surface of the front wall 201b of the socket 201, or the inner surface 103 of the outer shell 100. The retainer 400 is inserted such that a rear surface 404 thereof abuts the inner surface of the rear wall 201a of the socket 201. The retainer 400 is held in the socket 201 by friction, and is inserted far enough such that the retainer 400 is securely held. As noted above, the light-emitting element 500 may have a front shoulder 501 and rear shoulder 502. The light-emitting element 500 may be installed such that the front shoulder 501 abuts the inner surface of the front wall 201b of the socket 201 or the inner surface 103 of the outer shell 100. In the case where the outer shell 100 has holes 102 formed entirely through the outer shell, this front shoulder 501 prevents the light-emitting element 500 from being inserted all the way through the outer shell 100. As noted above, the retainer 400 includes a ridge 402a formed along the downward-opening groove 402. The retainer 400 in inserted such that the ridge 402a abuts the rear shoulder 502 of the light-emitting element 500. This prevents the light-emitting element 500 from falling out of its position, towards the rear. After the light-emitting elements 500 and retainers 400 are installed in the sockets, the upper lid 300 of the device may be secured to the outer shell 100. Upper lid 300 can be secured to the outer shell 100 by means such as screws, clips, or the like. The upper lid 300 can include an annular ridge 302, which is disposed in a space formed by an upper notch 407 of the retainer 400. This further immobilizes the retainers 400.

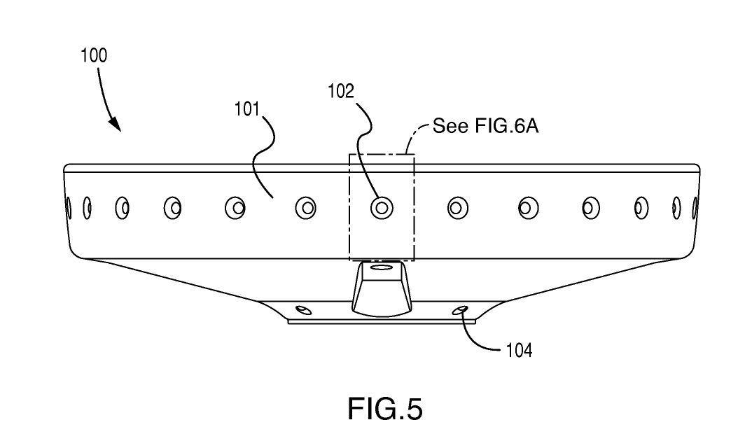

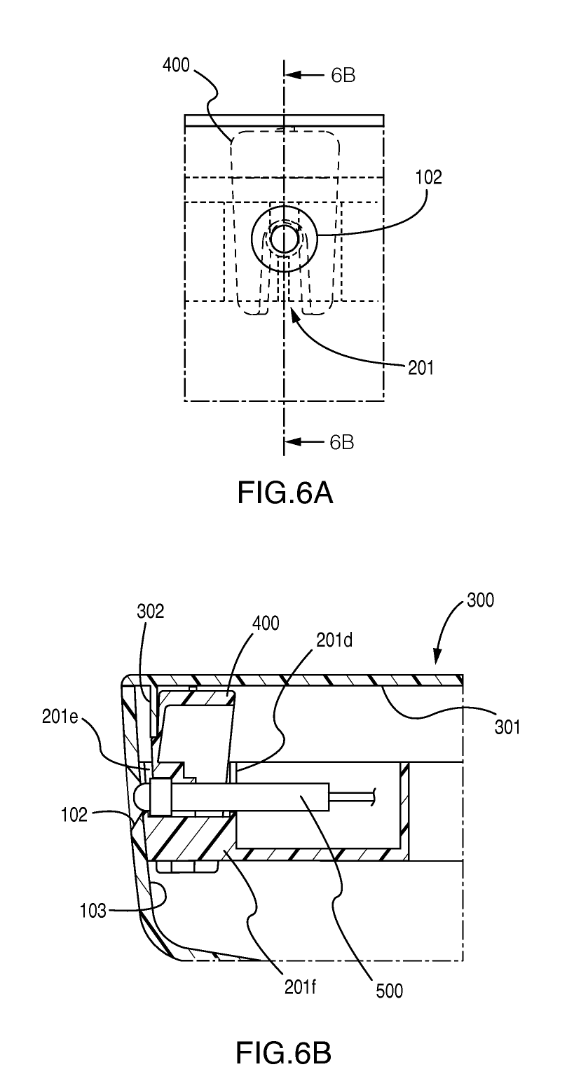

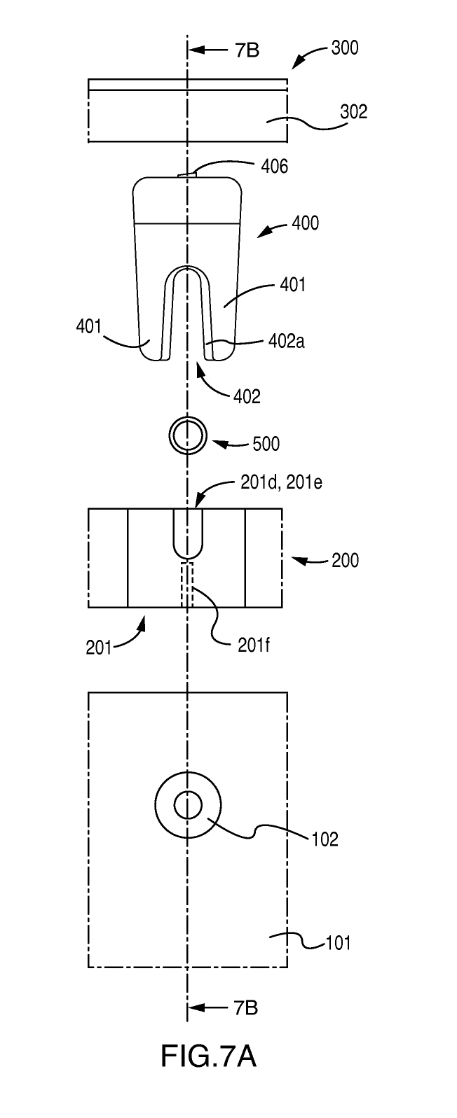

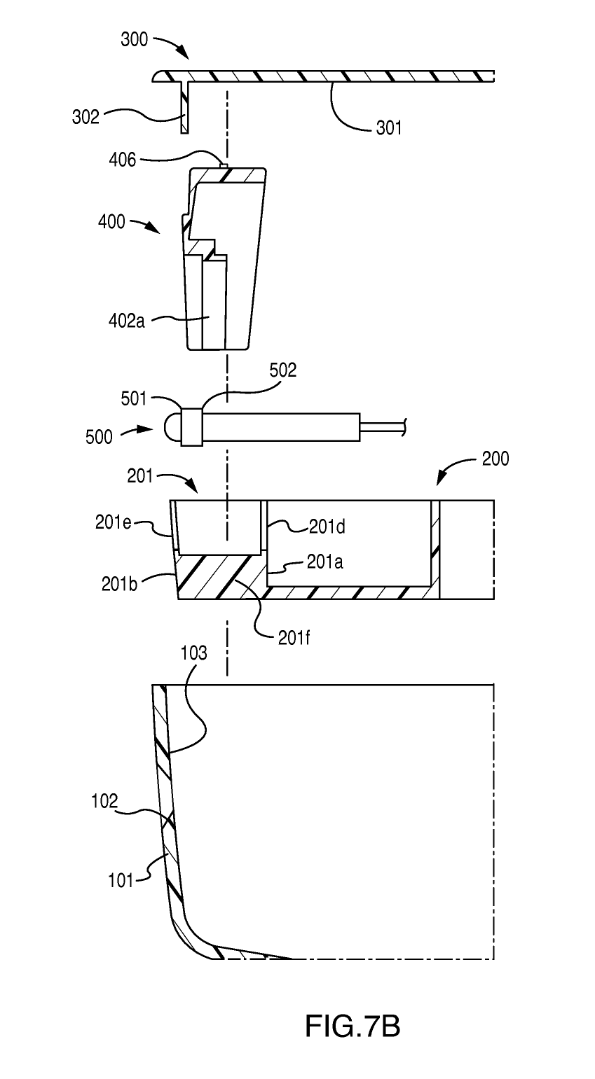

A particular embodiment of retaining configuration discussed above is illustrated in FIG. 5-7. FIG. 5 illustrates a detail portion. In FIGS. 6A and 7A, elements not visible behind the wall of outer shell 100 are illustrated in broken lines, to denote their position relative to the hole 102 in the outer shell 100, and to other elements. As shown in the assembled view in FIGS. 6A and 6B and the exploded view of FIGS. 7A and 7B, the tray 200 is inserted into the outer shell 100. The light-emitting element 500 is inserted into upward-opening groove 201e of front wall 201b and upward-opening groove 201d of rear wall 201a of socket 201. The retainer 400 is inserted into the socket 201, such that the light-emitting element 500 fits into the downward opening groove 402 of the retainer 400, and the leg portions 401 are disposed to the left and right of the light-emitting element 500. The front shoulder 501 of the light-emitting element 500 abuts the front wall 201b, and the rear shoulder 502 abuts the ridge 402a of the retainer 400. The upper lid 300 closes the cavity defined by the outer shell 100, such that the annular ridge 302 fits into a space defined by the notch 407 of the retainer 400.

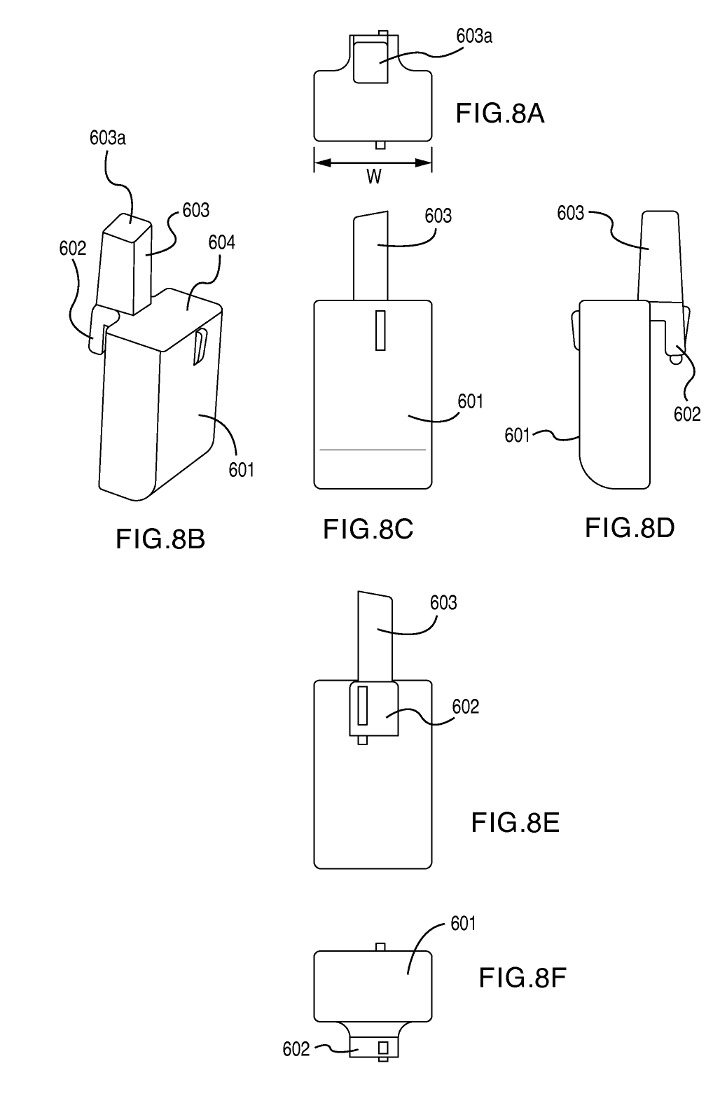

Additionally, in the case of the power source having significant weight (for example, in the case of batteries), one or more counterweights 600 can be included to balance this weight, thereby preventing the device from leaning significantly to one side when there is no user on the device. The counterweights 600 are illustrated in FIGS. 8A-8F, and include a body 601, a hook portion 602 and a tower portion 603. The counterweights 600 can be inserted into the device such that they are disposed in spaces between the sockets 201.

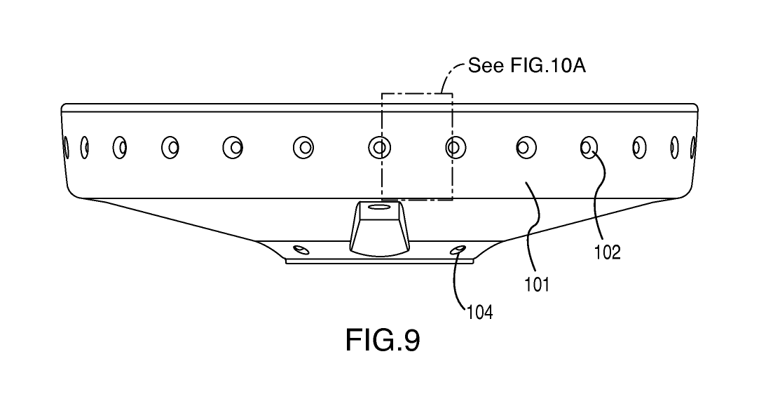

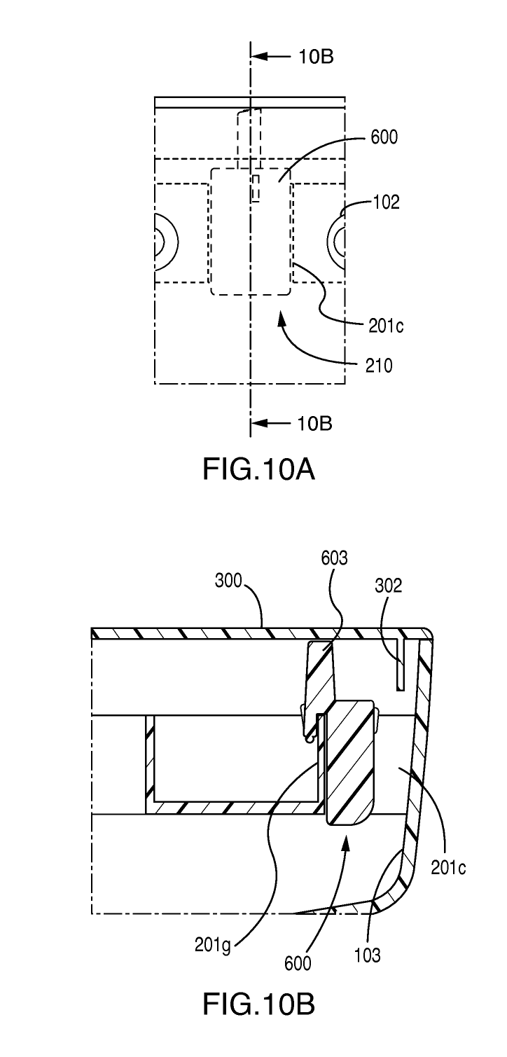

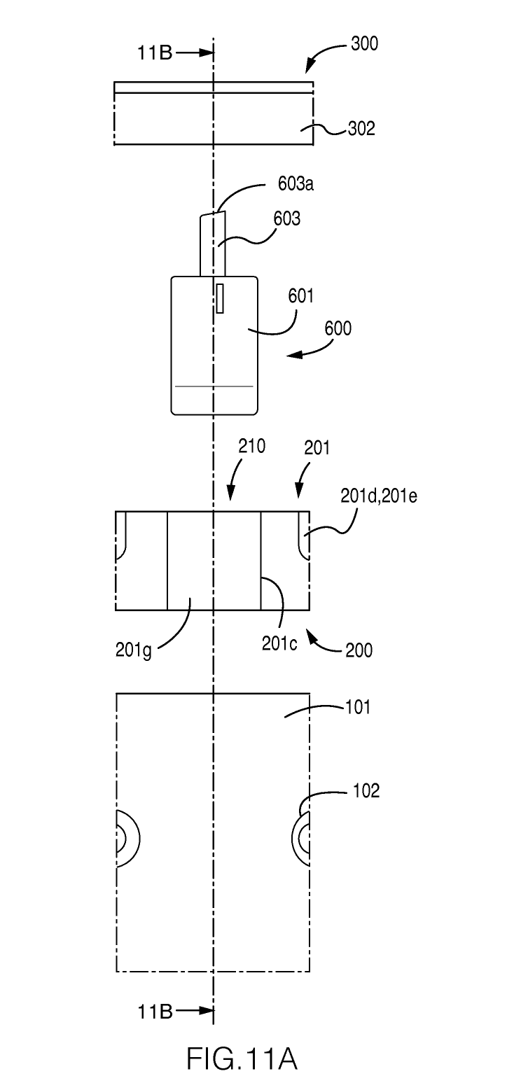

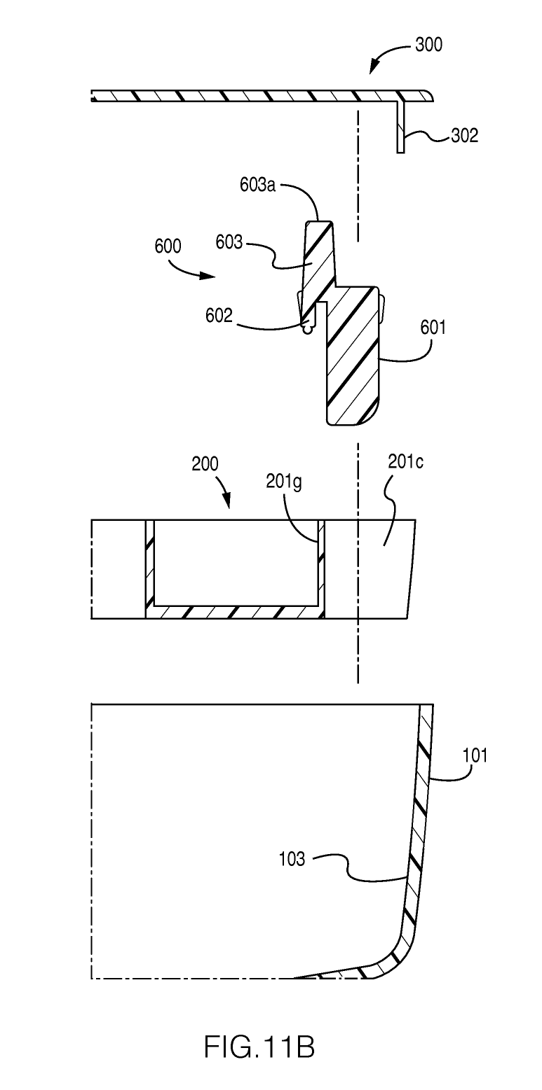

FIG. 9 illustrates a detail portion. FIGS. 10A, 10B, 11A and 11B illustrate the detail of FIG. 9. In FIGS. 10A and 11A, elements not visible behind the wall of outer shell 100 are illustrated in broken lines, to denote their position relative to holes 102 in the outer shell 100, and to other elements. The body 601 is formed such that the width W thereof is substantially equal to the width of the space 210 between the sockets 201, discussed above. In this situation, a connecting wall 201g is provided which is continuous with the rear walls 201a of the sockets 201. The hook portions 602 of the counterweights 600 retain the counterweights 600 on the connecting wall 201g. Due to the hook portion 602 and the width W of the counterweight 600 matching the space 210 between the sockets 201, the counterweight 600 is prevented from moving side-to-side or downwards. Additionally, the counterweights 600 include the tower portion 603 which extends from an upper surface 604 of the body 601. The height of the counterweight 600 is formed such that the upper surface 603a of the tower portion 603 abuts the inner surface 301 of the upper lid 300. As such, movement of the counterweight 600 in the vertical direction is prevented. The counter weights 600 may be formed of any appropriate material, such as plastic, rubber, metal or the like. The number and positioning of counterweights 600 is not particularly limited. In one embodiment, 4-8 counterweights 600 are installed, and are disposed on a side of the device opposite to the power source 170, particularly where the power source is a battery.

Additionally, the cavity of the outer shell 100 may also house electrical components, such as a power switch, a controller, and a power source. The power switch 190 may be in the form of a push button, toggle switch, sliding switch, or the like. The controller 180 may be a circuit board which controls the light-emitting element operation. The light-emitting element operation may be based on a pre-programed sequence in operation whenever the power switch is activated. Or, the light-emitting element operation may be intermittent, based on the output of a motion sensor or accelerometer (not illustrated). The power source 170 may be one or more battery, or another power source such as a solar cell, a fuel cell or a kinetic charger. In the case of a battery, the power source 170 may be one or more conventional battery sizes, such as AA, AAA, C or D. In the case of the power source 170 being a battery, a battery case may be formed in the outer shell 100, and a battery door may be included. The battery door may face the exterior of the device, or may face the interior of the device, in the cavity.

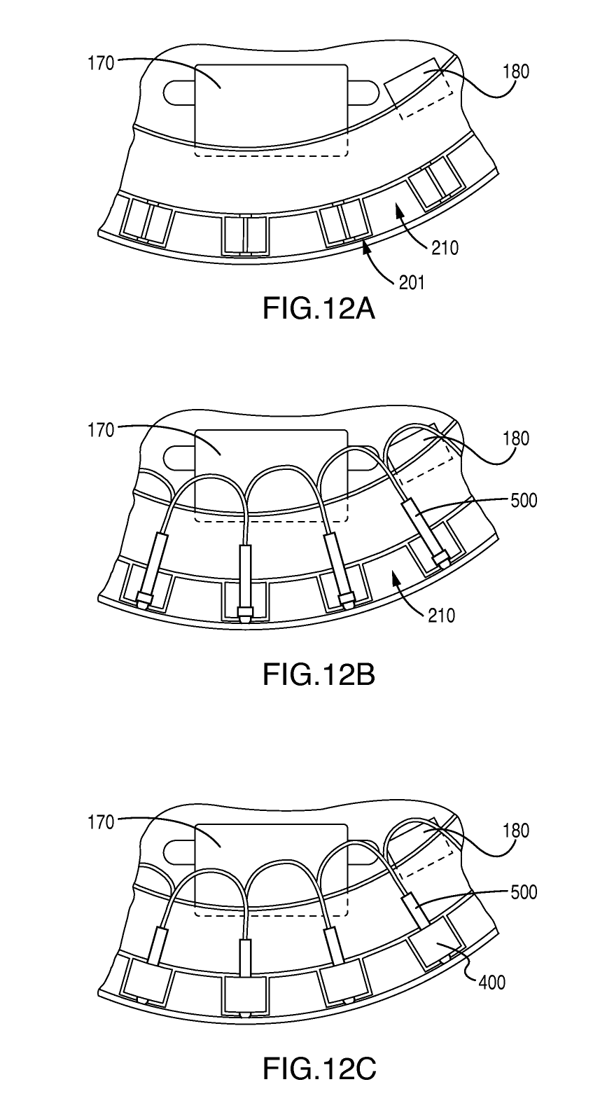

FIGS. 12A, 12B and 12C further illustrate the retaining configuration of the light-emitting elements 500, along with one configuration of the positioning of the power source 170 and controller 180. FIG. 12A is a partial top view, illustrating a condition where the tray 200 is inserted into the outer shell 100. FIG. 12B is a partial top view, illustrating a condition where the tray 200 is inserted into the outer shell 100 and light emitting elements 500 are inserted into the sockets 201. FIG. 12C is a partial top view, illustrating a condition where the tray 200 is inserted into the outer shell 100 and both the light emitting elements 500 and the retainers 400 are inserted into the sockets 201. It should be noted that in FIG. 12C, the retainers 400 are illustrated in a simplified manner. Additionally, it should be noted that this is only a partial view of the device, and the same configuration can be found around the entire periphery of the device. In such a case, at locations along the periphery of the device which are opposite to those illustrated in FIGS. 12A, 12B and 12C, and thus opposite to the power source 170, counterweights 600 can be inserted into the spaces 210 between the sockets 201.

Next, a further embodiment will be described. In this embodiment, in addition to the light-emitting elements 500 secured in the sockets 201, around the periphery of the device, light-emitting elements 500 can be included which emit light from the bottom of the device. This is illustrated in FIGS. 13 and 14. FIG. 13 illustrates a detail, and this detail is illustrated in top plan view in FIG. 14A. It is noted that in FIG. 13, a portion of the tray 200 is cut away in order to more clearly illustrate the detail, but this portion of the tray 200 is represented in FIG. 14B. As similar configuration is provided at, for example, four locations on the tray 200 and outer shell 100. Specifically, in the embodiment described above including the tray 200, this tray can be used to retain additional light-emitting elements 500. As noted above, the outer shell 100 can be formed to include mounting bosses 110 which have a hole opened on an upper end thereof, and the tray 200 can be connected to the outer shell 100 via these mounting bosses 110. Additionally, a light-emitting element receiving bosses 120 can be provided adjacent to the mounting bosses 110 at positions which will be covered by the central portion 220 of the tray 200. The mounting bosses 110 and the light-emitting element receiving bosses 120 can be connected by a support wall, as shown in the figures, but this is not necessary. The light-emitting element receiving bosses 120 are formed so as to have an inner diameter substantially the same as the maximum outer diameter of the light-emitting elements 500, and so as to have a depth substantially equal to the length of the light-emitting element 500.

The light-emitting element receiving bosses 120 may be continuous with hole 104 formed in the bottom of the outer shell 100. Alternatively, in the case where the outer shell 100 is translucent, the light-emitting element receiving bosses 120 may not communicate with a hole, and emitted light may pass through the outer shell 100 at a position below the light-emitting element receiving bosses 120. The light-emitting elements 500 can be inserted into the light-emitting element receiving bosses 120, prior to the securing of the tray 200. The front shoulder 501 of the light-emitting elements 500 abuts a ridge 121 within the light-emitting element receiving bosses 120, thus preventing the light-emitting element 500 from being inserted all the way through the holes 104, if present. When the tray 200 is secured to the outer shell 100, via screws, clips or the like at the mounting bosses 110, the light-emitting elements 500 are retained by the central portion 220 of the tray 200. In the central portion 220 of the tray 200, there may be provided an opening at least in the position corresponding to the light-emitting element receiving bosses 120, so as to allow for space for the wires which electrically connect the light-emitting elements 500 to the power source 170 and the like.

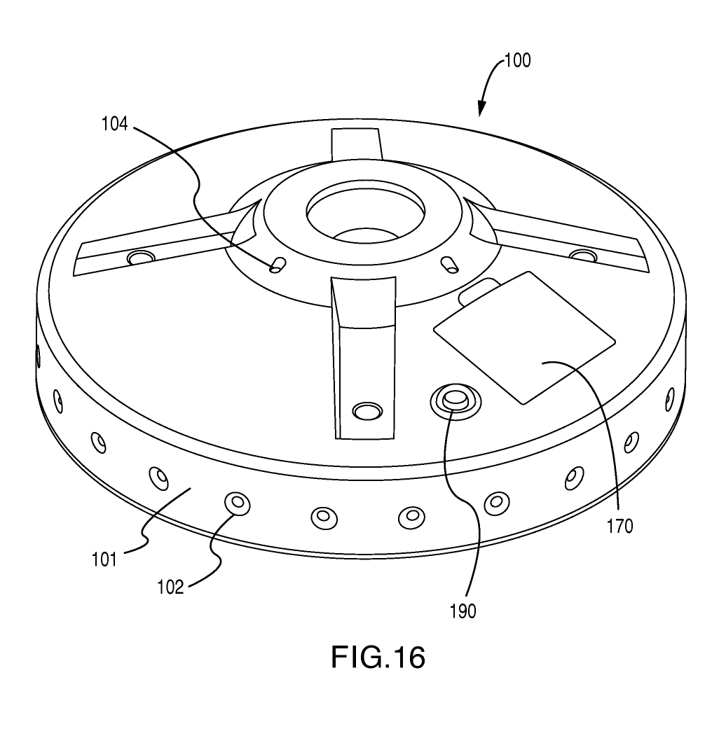

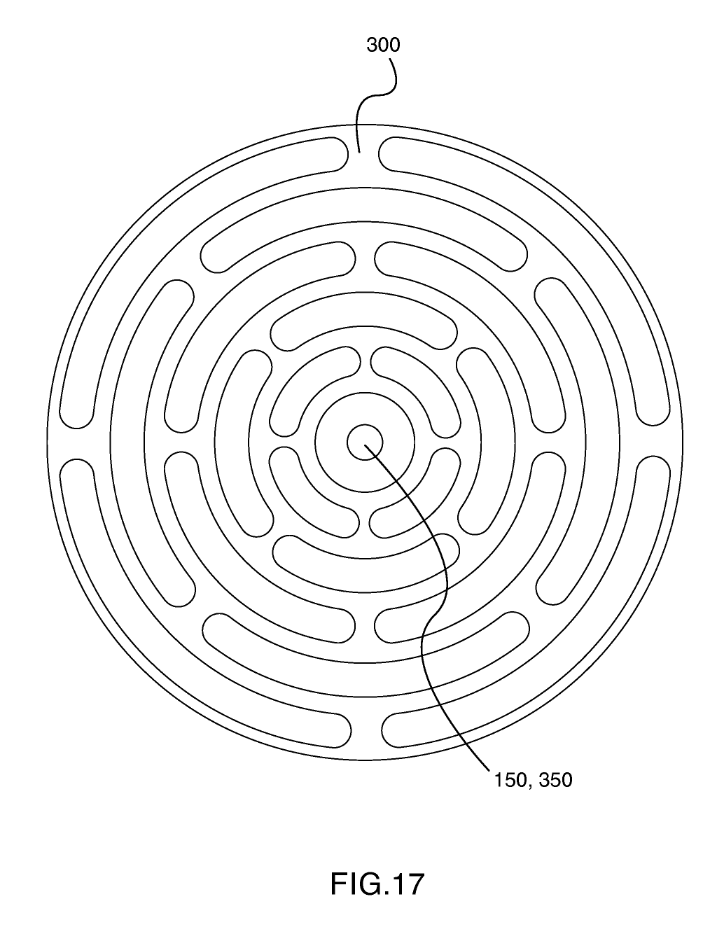

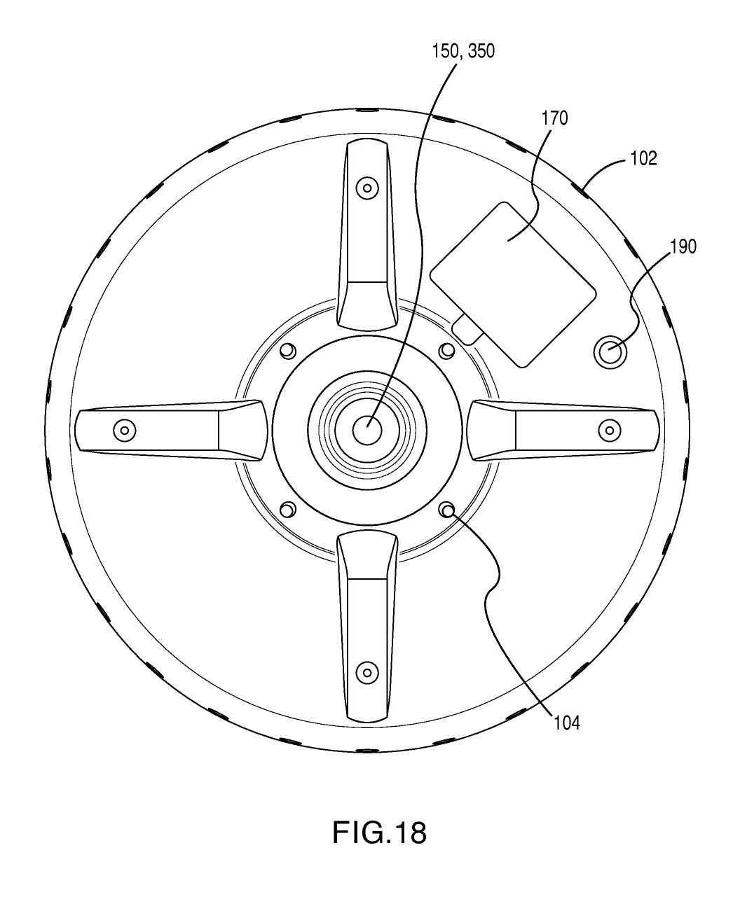

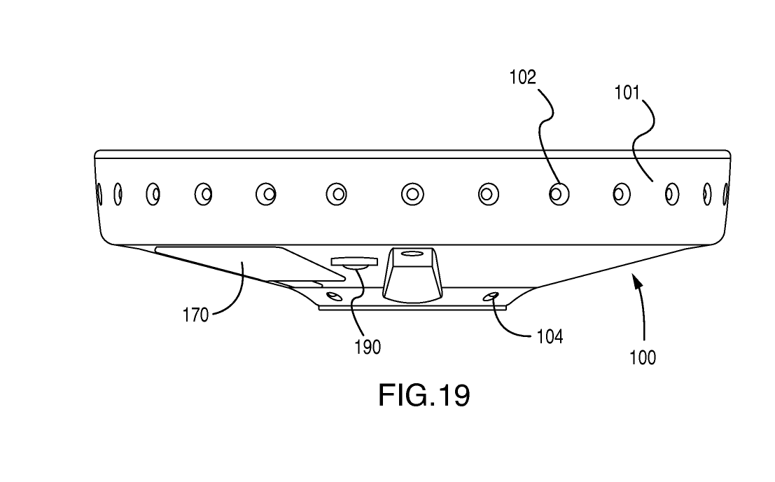

FIGS. 15-19 illustrate the external appearance of an assembled device, in one particular embodiment. Specifically, FIG. 15 is a top perspective view of an assembled embodiment of the device, FIG. 16 is a bottom perspective view of the assembled embodiment of the device, FIG. 17 is a top view of the assembled embodiment of the device, FIG. 18 is a bottom view of the assembled embodiment of the device, and FIG. 19 is a side view of the assembled embodiment of the device. However, the device may have a different external appearance.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention which is to be determined by the following claims.

We claim:

1. An illuminated device, comprising:
an outer shell defining a cavity therein,
a plurality of sockets disposed within the cavity of the outer shell, around a periphery of the outer shell, the plurality of sockets each comprising at least a pair of opposing side walls and a rear wall having an upward-opening groove formed therein,
a plurality of light-emitting elements fitted into the upward-opening grooves formed in the rear walls of the plurality of sockets, and
a plurality of retainers disposed in the plurality of sockets,
wherein the plurality of light-emitting elements are each held by the upward-opening groove formed in the rear wall of one of the plurality of sockets and one of the plurality of retainers.

2. The illuminated device of claim 1, further comprising:
a tray removably disposed within the outer shell, the tray comprising the plurality of sockets on an outer periphery thereof, each of the plurality of sockets comprising
the two opposing side walls,
a front wall orthogonal to the two opposing side walls, and
the rear wall, orthogonal to the two opposing side walls,
wherein the front wall and the rear wall connect the two opposing side walls, the front wall having an upward-opening groove formed therein, and
wherein the plurality of light-emitting elements are each held by the upward opening groove formed in the front wall of one of the plurality of sockets, the upward opening groove formed in the rear wall of the one of the plurality of sockets, and one of the plurality of retainers.

3. The illuminated device of claim 2, wherein the plurality of retainers are removably inserted in the plurality of sockets.

4. The illuminated device of claim 2, wherein the plurality of retainers each comprise two leg portions defining a downward-opening groove therebetween, the plurality of light-emitting elements being disposed within the downward-opening grooves of the plurality of retainers.

5. The illuminated device of claim 4,
wherein the plurality of retainers each comprise a ridge formed on an inner surface of the downward-opening groove, and
wherein the ridge abuts a rear shoulder of one of the plurality of light-emitting elements.

6. The illuminated device of claim 4, wherein the plurality of sockets further comprise a reinforcing beam which connects a midpoint of the front wall and a midpoint the rear wall, such that the light-emitting element is disposed above the reinforcing beam and at least partially below one of the plurality of retainers.

7. The illuminated device of claim 2,
wherein the outer shell comprises mounting bosses on an inner surface of a bottom portion of the outer shell, and
wherein the tray is removably attached to the outer shell by a connector which connects the tray to the mounting bosses.

8. The illuminated device of claim 7,
wherein the outer shell further comprises light-emitting element receiving bosses adjacent to the mounting bosses, and
wherein the tray is removably attached to the outer shell such that light-emitting elements are immobilized in the light-emitting element receiving bosses by the tray.

9. The illuminated device of claim 1,
wherein an outer peripheral wall of the outer shell is circular in plan view.

10. The illuminated device of claim 9, wherein a hole is formed in the outer shell at a central portion, in plan view, such that a rope or cable is insertable therethrough.

11. The illuminated device of claim 2, wherein the plurality of light-emitting elements are electrically connected to a power source and a controller by wiring.

12. The illuminated device of claim 1,
wherein a plurality of holes are at least partially formed in an outer peripheral wall of the outer shell, the plurality of light-emitting elements being at least partially inserted into the plurality of holes, and
wherein the upward-opening grooves formed in the rear walls of the plurality of sockets are aligned with the plurality of holes.

13. The illuminated device of claim 2,
wherein a plurality of holes are at least partially formed in an outer peripheral wall of the outer shell, the plurality of light-emitting elements being at least partially inserted into the plurality of holes, and
wherein the upward-opening grooves formed in the front and rear walls of the plurality of sockets are aligned with the plurality of holes.

14. The illuminated device of claim 1, wherein the outer shell is translucent or transparent.

15. The illuminated device of claim 1, further comprising one or more counterweights removably inserted into one or more spaces between adjacent sockets among the plurality of sockets, said one or more counterweights each comprising a hook which can be disposed on a connecting wall which connects rear walls of said adjacent sockets among the plurality of sockets.

16. The illuminated device of claim 1, wherein the counterweights each include a tower portion extending from an upper surface of a body of said counterweights, the upper surface of said tower portion abutting an inner surface of an upper lid which closes the cavity defined by the outer shell.

17. An illuminated device, comprising:
an outer shell defining a cavity therein,
a tray removably disposed within the outer shell, the tray comprising a plurality of sockets on an outer periphery thereof, each of the plurality of sockets comprising
two opposing side walls,
a front wall orthogonal to the two opposing side walls, and
a rear wall orthogonal to the two opposing side walls, and
a reinforcing beam which connects a midpoint of the front wall and a midpoint of the rear wall, and
a plurality of retainers removably inserted in the plurality of sockets, the plurality of retainers each comprising two leg portions defining a downward-opening groove therebetween and having a ridge formed on an inner surface of the downward-opening groove,
wherein the front wall and the rear wall connect the two opposing side walls, the front wall and the rear wall each having an upward-opening groove formed therein,
wherein a plurality of light-emitting elements are inserted into the upward opening grooves formed in the front walls and the rear walls of the plurality of sockets, such that each of the plurality of light-emitting elements is disposed above the reinforcing beam and at least partially below one of the plurality of retainers,
wherein the ridge formed on the inner surface of the downward-opening groove of the retainer abuts a rear shoulder of one of the plurality of light-emitting elements,
wherein the plurality of light-emitting elements are each held by the upward opening groove formed in the front wall of one of the plurality of sockets, the upward opening groove formed in the rear wall of the one of the plurality of sockets, and one of the plurality of retainers, and are disposed within the downward-opening groove of the one of the plurality of retainers,
wherein a plurality of holes are at least partially formed in an outer peripheral wall of the outer shell, the plurality of light-emitting elements being at least partially inserted into the plurality of holes, and
wherein the upward-opening grooves in the front and rear walls of the plurality of sockets are aligned with the plurality of holes.

18. The illuminated device according to claim 17,
wherein the outer shell comprises mounting bosses on an inner surface of a bottom portion of the outer shell,
wherein the tray is removably attached to the outer shell by a connector which connects the tray to the mounting bosses,
wherein the outer shell further comprises light-emitting element receiving bosses adjacent to the mounting bosses, and
wherein the tray is removably attached to the outer shell such that light-emitting elements are immobilized in the light-emitting element receiving bosses by the tray.

19. The illuminated device of claim 1, wherein the outer shell is translucent or transparent.
